(19) United States
(12) Patent Application Publication
(10) Pub. No.: US 2010/0065289 A1
(43) Pub. Date: Mar. 18, 2010

(54) Automatic fire extinguisher for a wood-burning pool heater

(76) Inventors: Augie Ciulla, White Haven, PA (US); Robert J Ianuale, Hazlet, NJ (US)

Correspondence Address: Robert J. lanuale, 2 Ned Drive, Hazlet, NJ, 07730, US

(21) Appl. No.: 12/283,623

(22) Filed: Sep. 15, 2008

(51) Int. Cl. A62C 3/00

(52) U.S. Cl. 169/54

(57) ABSTRACT

Wood-burning pool heaters are not designed to automatically extinguish their fires when the water flow through the heater is interrupted. In these situations, the water remaining in the heater would be heated sufficiently to melt the pipes connecting to the pool pump and filter system, which could possibly damage the heater, as well. Manufacturers of wood-burning pool heaters warn users to extinguish the fire immediately. The present invention provides an automatic means of extinguishing the fire immediately, without any user intervention.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

With the rising costs of oil and natural gas, the utilization of wood-burning heaters has become a much more economical method to heat residential swimming pools. However, while the energy to burn wood costs much less, the risks for heater and water pipe damage greatly increase. Power outages or interruptions in the water flow through the heater may cause the temperature to rise dramatically, damaging the heater and the pipes connected to the pool pump and filter system.

Presently, the solution to this problem is a general warning to the user to “extinguish the fire immediately” (http://www.extendaswim.com/heatersetup.html (R1) and http://www.woodheatedpools.com/gpage4.html (R2)). The user may not always be immediately aware of an interruption in the water flow. The ability to extinguish the fire immediately may not be possible, with system damage already occurring.

Even when “How to heat outside pool with wood burning stove?” was posted on the Internet, the originator-selected best answer included a warning which paraphrased the above concern: “Always let your fire go out before turning off the water flow” (http://uk.answers.yahoo.com/question/index?qid=20070728114616AAe92zi (R3)). Of course, if the user does not turn the water off, but instead experiences a problem that cuts off the water flow, he would find out too late why the fire should always “go out before” the water flow is turned off or stopped.

### BRIEF SUMMARY OF THE INVENTION

The present invention is able to automatically extinguish the fire in a wood-burning pool heater immediately when there is an interruption in the water flow without requiring human intervention, thereby protecting the integrity of the heater and all the pipes which connect it to the pool pump and filter system.

### BRIEF DESCRIPTION OF THE SEVERAL VIEWS OF THE DRAWING

The accompanying drawings illustrate the invention. In such drawings:

FIG. 1 is the front view of the water tank of the present invention;

FIG. 2 is a side view of the water tank;

FIG. 3 is the bottom view of the water tank;

FIG. 4 is a the top view of the water tank;

FIG. 5 is a side view of the water tank as it sits atop an existing heater;

FIG. 6 is the front view of a transition piece of the present invention;

FIG. 7 is the side view of a transition piece;

FIG. 8 is the inside back of the associated heater;

FIG. 9 is the back of the heater;

FIG. 10 is a side view of the present invention atop a heater; and

FIG. 11 is a side view of the present invention in operation.

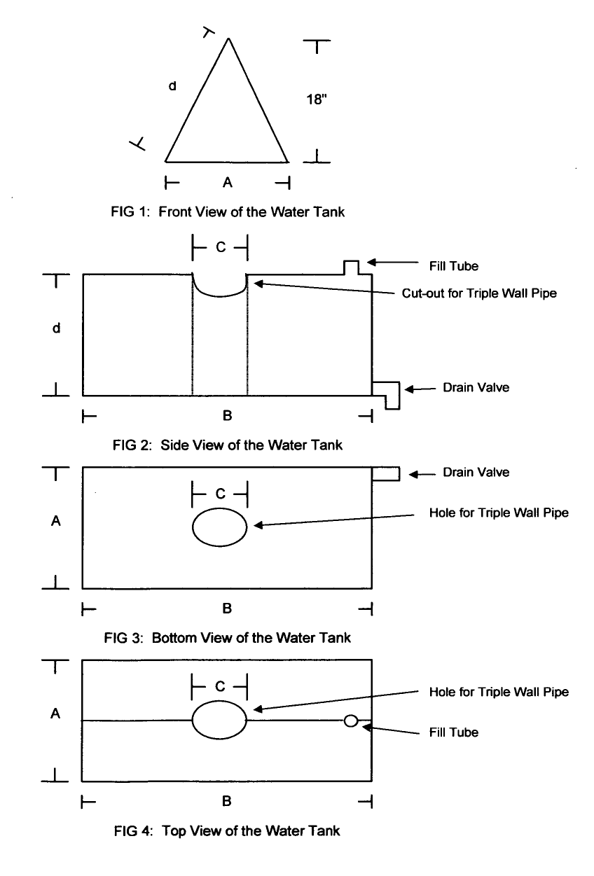

### DETAILED DESCRIPTION OF THE INVENTION

Wood-burning heaters can be obtained specifically for use as pool heaters or can be adapted from other uses. The present invention would be compatible with all heaters to assure there is a sufficient amount of water available within the water tank portion of the invention to completely extinguish the fire.

The invention can be positioned at any height above the wood-burning heater; the preferred method is to position it directly over the heater. The width, length, height and shape of the invention can also be adjusted by the user. Specific dimensions are provided herein to simplify the design. The preferred width (A) of the invention would equal the width of the heater to optimize both the water capacity and the aesthetics of the finished product with respect to the heater. The preferred length (B) of the invention would be approximately six (6) inches longer than the heater, providing a suitable overhang to accommodate the temperature control valve section of the invention. The preferred height of the invention would be approximately eighteen (18) inches, and preferably constructed in a triangular shape (see FIG. 14).

The invention can be constructed from any material that would be strong enough to hold the required amount of water without allowing any rust to form on the inside. The preferred material would be ⅛-inch thick aluminum sheets to provide the desired strength at a reasonable cost.

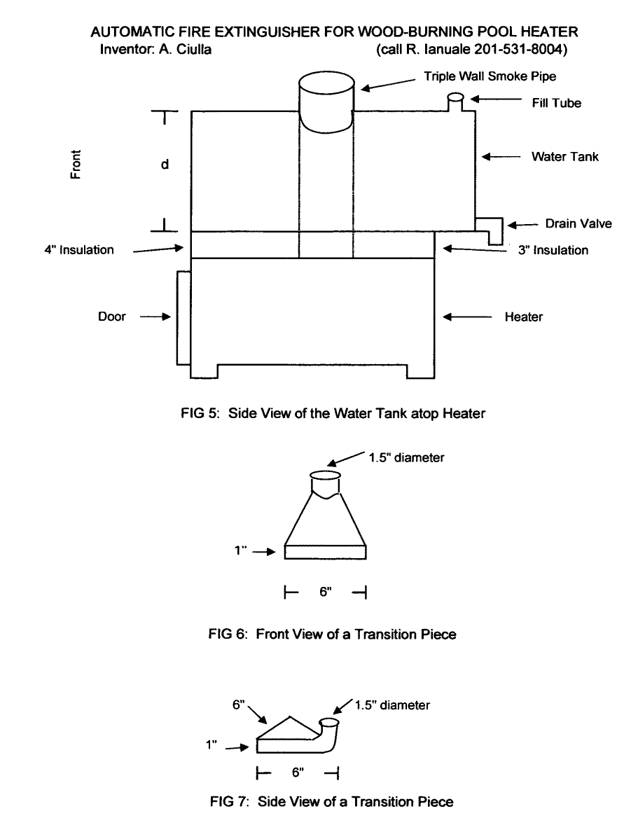

The invention preferably includes a triple-wall smoke pipe that will replace the first 24-inch section of the heater's chimney pipe. The diameter (C) of the resulting smoke pipe will determine the associated cut-outs in the bottom and/or sides and/or top of the invention to accept the triple-wall smoke pipe, allowing the invention to preferably sit directly atop the heater (see FIG. 5). The reason for using a triple-wall or similar smoke pipe is to effectively reduce the amount of heat that could transfer from the smoke pipe to the water contained in the water tank portion of the invention.

The water tank of the invention preferably includes a fill tube, preferably with a screw-on cap. The cap is such that it will allow sufficient air to enter the invention in order not to impede the flow of water when the invention is activated. The fill tube is preferably 2 inches high and 2 inches in diameter, to allow filling, e.g., with a hose.

The water tank of the invention preferably includes a drain valve to allow drainage of the invention, e.g., during the winter. The drain valve would preferably allow connection to a garden hose to direct the flow of the water so drained.

The water tank portion of the invention includes an opening in the bottom rear to direct the water toward the heater, welded preferably to a 1½-inch galvanized pipe. A temperature control valve is located at and connected to the opening via the pipe. The valve, preferably a 1½-inch valve, is normally in the off position, keeping the water inside the water tank portion of the invention. The valve sensor is located in the flowing pool water, preferably at the outlet pipe of the existing heater and is set to a suitable threshold temperature, such as 120° F. The invention could include multiple openings with multiple valves both to increase the amount of water flow and to provide contingencies in case the primary valve should not function correctly. However, the preferred invention would include two (2) such openings/pipes with two (2) such valves to meet these criteria.

The output of the valve, or each valve in the case of multiple valves, connects to a 1½-inch elbow, which is welded to a transition piece. The transition piece directs the water through the back of the heater. The shape and dimensions of the transition piece can be varied by the user but a typical transition piece would be one (1) inch high by six (6) inches wide (see FIGS. 6-7). As with the rest of the invention, any suitable material can be utilized, but ⅛-inch aluminum is preferred. The number of transition pieces will match the number of valves, so preferably there will be two (2) transition pieces.

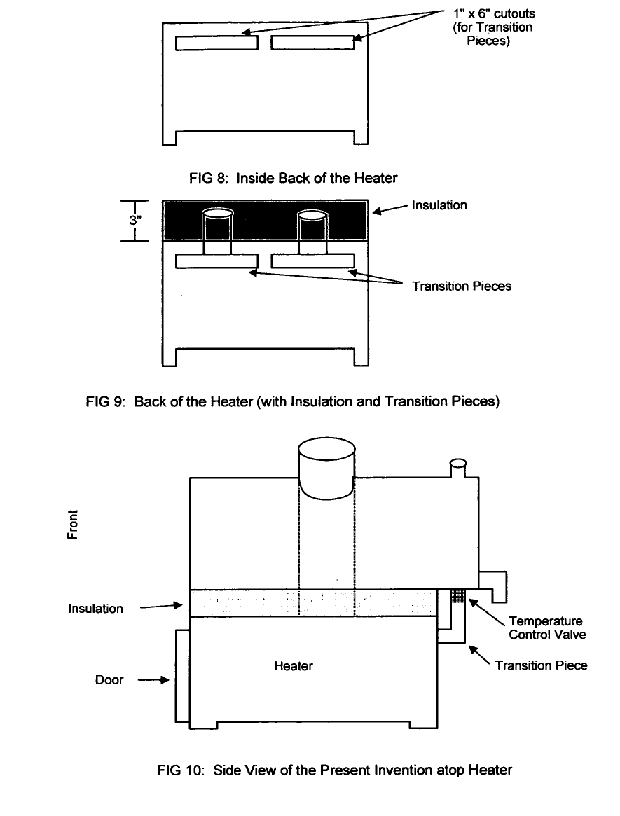

A one (1) inch by six (6) inch cutout is made at the back of the heater to meet with each transition piece (see FIG. 8). With the preferred two (2) valves of the invention, the back of the heater (FIG. 9) is shown.

The length from the bottom of the water tank, past the valve to the connecting elbow can be varied by the user, if desired, to modify the position of the transition pieces. Decreasing the height of the transition pieces can create a back pressure that, in addition to gravity, will help to quickly dump the water onto the fire in the heater.

When the invention is situated on top of the associated heater, appropriate insulation, preferably high-heat insulation, would be used to prevent heat transfer from the heater to the invention. The insulation should be tapered so that the invention allows the water from the water tank to exit through the open temperature control valves as quickly as possible. When a twenty-four (24) inch smoke pipe is utilized and the height of the invention is eighteen (18) inches, a preferable four (4) inch piece of insulation would leave two (2) inches of the smoke pipe for connection to the existing chimney pipe. Preferably tapering the insulation to three (3) inches at the back would provide a sufficient slope for the water inside the invention to quickly move toward and through an open temperature control valve (see FIG. 10).

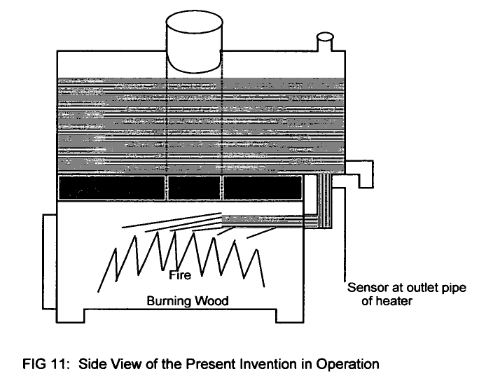

When the water flow to the pool from the heater is interrupted, the temperature of the water remaining within the heater will rise. If this is not corrected or if there is any other condition which causes the temperature threshold to be reached, the valve(s) will open and the water inside the invention will flow through the transition pieces and into the heater to extinguish the fire (see FIG. 11).

Another embodiment of the invention would incorporate the above stand-alone invention into the overall design of a wood-burning heater to accomplish heating a pool with a built-in automatic fire extinguisher.

We claim:

1. An automatic fire extinguisher for a wood-burning pool heater.

2. A wood-burning pool heater that includes an automatic fire extinguisher.

3. A method to automatically extinguish a fire in a wood-burning pool heater comprising:
(a) monitoring the temperature of the water that flows to the pool;
(b) opening a valve automatically when the temperature in (a) exceeds a pre-determined threshold; and
(c) directing a sufficient amount of water to pass through the valve in (b) to extinguish the fire in the heater.
